(19) United States
(12) Patent Application Publication
(10) Pub. No.: US 2013/0248048 A1
(43) Pub. Date: Sep. 26, 2013

(54) Insert for a Filler Neck of a Urea Container

(71) Applicant: Kazem Behnamrad, Winnenden (DE)

(72) Inventor: Kazem Behnamrad, Winnenden (DE)

(73) Assignee: Reutter GmbH, Leutenbach (DE)

(21) Appl. No.: 13/991,299

(22) PCT Filed: Nov. 28, 2011
(86) PCT No.: PCT/EP2011/071103

§ 371 Date: Jun. 3, 2013

(30) Foreign Application Priority Data
Dec. 4, 2010 (DE) 20 2010 016 319.6

(51) Int. Cl. B60K 15/04

(52) U.S. Cl. CPC B60K 15/04
USPC 141/311 R

(57) ABSTRACT

An insert for a filler neck of a urea container in diesel-operated motor vehicles, preferably lorries, wherein two plastic components which preferably engage into one another and receive, between them, a preferably annular component which is composed of magnetic material and is magnetized permanently before the installation, are welded to one another in a gas-tight and liquid-tight manner.

The invention relates to an insert for a filler neck of a urea container in diesel-fueled motor vehicles, preferably trucks, as defined by the preamble to claim 1.

To ensure that urea cannot be fed into fuel tanks, feed nozzles for urea are equipped with a safety valve, which is unlocked via a ring magnet in the filler neck. This arrangement has stood the test of time in trucks.

For reducing the cost of such filler necks, which are solidly connected to the urea container, it is the object of the present invention to create an insert that is suitable for being retroactively built into the filler neck and both has a simple structure and is quick to install.

For attaining this object, in an insert of this type for a filler neck of a urea container, the features recited in claim 1 are provided.

By the provisions of the invention, it is attained that the insert can be assembled together with the permanent magnet, which is magnetized before installation, quickly and easily, since a magnetizing device, required during assembly, need not be kept on hand and used. Moreover, because the two plastic components are welded together, further seals, for instance in the form of ring seals are the like, are unnecessary. This leads to further simplifications and economies.

If in a further embodiment of the present invention the features of claim 2 are provided, this makes it possible to monitor the tightness of the space between the two plastic components, in which space the permanent magnet is received.

Further advantageous embodiments will become apparent from the features of one or more of claims 3-6.

A preferred embodiment of the insert with regard to its disposition in a filler neck will become apparent from the features of claim 7.

Further details of the invention can be learned form the ensuing description, in which the invention is described and explained in further detail in terms of the exemplary embodiment shown in the drawing.

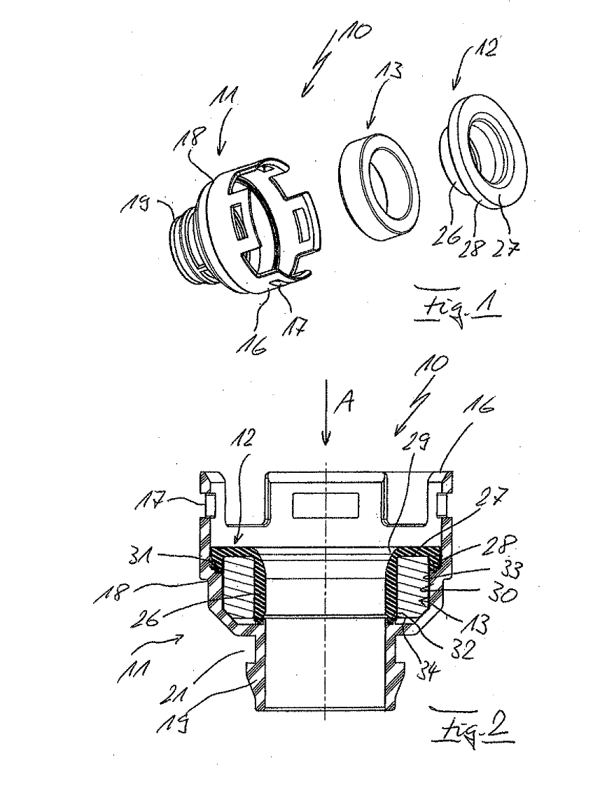

FIG. 1, in an exploded perspective view, shows an insert for a filler neck of a urea container in a preferred exemplary embodiment of the present invention; and

FIG. 2 is a longitudinal section through the insert of FIG. 1, in the assembled state.

For filling a urea container, not shown, the insert 10 shown in the drawing is inserted into the filler neck of the urea container, so that with the aid of a feed nozzle for urea, the urea container can be filled without causing fuel to be mistakenly fed in as well.

The insert 10 comprises three parts, namely two plastic components 11 and 12 and one permanent magnet 13.

One plastic component 11 is a graduated cylindrical receiving element which can be indirectly clipped or introduced in bayonet fashion into the filler neck, not shown. The receiving element 11 is graduated multiple times on the outer and inner circumference, and on its front end, in terms of the direction indicated by the arrow A, it has a crownlike part 16 with circumferentially distributed indentations 17, an adjoining graduated receiving region 18, and adjoining that, a cylindrical region 19 of smaller diameter that is provided with an annular groove 21 on its outer circumference. The receiving element 11 is embodied in one piece.

The second plastic component 12 forms an inner guide element, which is formed in one piece of an axially extending tubular part 26 and, extending horizontally perpendicular to it, a radially extending annular rim 27, which in turn is provided on its outer circumference, axially in the direction of the arrow A and parallel to the tubular part 26, with a crimped edge 28. At the transition from the tubular part 26, which serves as an axial boundary wall with respect to the annular rim 27 that in turn serves as a radial covering wall, the encompassing inner edge 29 is embodied in polygonal or rounded fashion. The inside diameter of the tubular part 26 is equivalent to that of the cylindrical region 19 of the receiving element 11.

The permanent magnet 13, which in the exemplary embodiment is embodied annularly, comprises a magnetic material, such as NdFeB, and is magnetized before the insert 10 is installed. The permanent magnet, which is delivered in the magnetized state, is received between the two plastic components 11 and 12.

In FIG. 2, the inner guide element 12, by its free annular end of the crimped edge 28, and by the lower annular end of the cylindrical region 19, respectively, is set onto an upper first annular graduated face 31 and a lower second annular graduated face 32 of a setback 30 of the receiving element 11. The permanent magnet 13, delivered in the magnetized state, is located then in a chamber 33 between the inner guide element 12 and the receiving element 11. At a lower end, in terms of the direction of the arrow A, of the receiving chamber 33, in which the permanent magnet 13 is received between the two plastic components 11 and 12, there is a remaining an air space 34, which is not filled by the permanent magnet 13. In other words, the axial length of the permanent magnet 13 is somewhat less than the axial dimension of the receiving chamber 33 between the two plastic components 11 and 12. Otherwise, the cross section of the permanent magnet 13 is equivalent to the cross section of the chamber 33, minus the air space 34.

In this state, the two plastic components 11 and 12 are welded ultrasonically in gas- and fluid-tight fashion at their contacting annular faces. After the ultrasonic welding of the two plastic components 11 and 12, the remaining space 34 remains filled with air, by way of the internal pressure of which the tightness of the ultrasonic welding can be monitored.

1-7. (canceled)

8. An insert for a filler neck of a urea container in diesel-fueled motor vehicles, preferably trucks, comprising:
two preferably internested plastic components; and
an annular component element received, wherein:
said annular component element comprises between them magnetic material which is permanently magnetized before being installed; and
all components are welded to one another in gas-tight and fluid-tight fashion.

9. The insert according to claim 8, wherein:
between the two plastic components a receiving chamber is formed, the volume of which is somewhat greater than the volume of said annular component element that is magnetized into a permanent magnet.

10. The insert according to claim 8, wherein:
said two plastic components are formed by a receiving element embodied in graduated fashion on the inner and outer circumference and by an annular inner guide element that covers a setback of the receiving element.

11. The insert according to claim 10, wherein:
said annular inner guide element rests on two radially and axially spaced-apart graduated faces of said receiving element.

12. The insert according to claim 10, wherein:
said annular inner guide element is rounded at an inner edge between a radial covering wall and an axial boundary wall.

13. The insert according to claim 8, wherein:
said two plastic components are ultrasonically welded.

14. The insert according to claim 8, wherein:
the insert is embodied such that it can be indirectly clipped or inserted in bayonetlike fashion into a filler neck.
